(19) United States
(12) Patent Application Publication
(10) Pub. No.: US 2010/0245090 A1
(43) Pub. Date: Sep. 30, 2010

(54) PATIENT THERMAL MONITORING SYSTEM

(75) Inventors: Toby E. Smith, Broken Arrow, OK (US); Craig L. Cooper, Inola, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: BED-CHECK CORPORATION, TULSA, OK (US)

(21) Appl. No.: 12/535,400

(22) Filed: Aug. 4, 2009

Related U.S. Application Data
(63) Continuation-in-part of application No. 11/132,772, filed on May 19, 2005, now abandoned.
(60) Provisional application No. 60/572,535, filed on May 19, 2004.

(51) Int. Cl. G08B 23/00

(52) U.S. Cl. 340/573.1

(57) ABSTRACT

A patient temperature monitoring system is provided herein that takes the form of an electronic patient monitor that is used in conjunction with a thermocouple sensor that has been printed or otherwise placed on a flexible surface such as a mat. The thermocouple sensor that is taught herein is more comfortable for the patient, more reliable, and can be manufactured with less cost than has heretofore been possible. According to a preferred embodiment, a finely powdered metal ink containing, for example, iron will first be silk screened onto a substrate. Then a second metal ink will be screened onto the same substrate so as to intersect the first, the second metal being preferably being some combination of nickel and copper, the first and second metal inks being chosen to form a thermocouple.

This application claims the benefit of U.S. Provisional Patent Application Ser. No. 60/572,535 that was previously filed on May 19, 2004. It also claims the benefit of co-pending U.S. patent application Ser. No. 11/132,772, filed May 19, 2005, the disclosures of all of the foregoing being incorporated by reference into this document as if set out at this point.

### FIELD OF THE INVENTION

The present invention relates generally to patient monitoring and, more particularly, to the design, manufacture, and operation of printed thermocouples for use in monitoring the temperature condition of a patient.

### BACKGROUND OF THE INVENTION

It is well known that the use of electronic devices to monitor a patient's status is a growing trend in healthcare settings. This trend can be attributed to any number of factors including the increased vigilance that can be obtained with electronic monitoring (e.g., electronic monitors never sleep or leave the patient's vicinity for a break), decreased staffing costs (e.g., one caregiver can cover multiple patients), etc.

As a specific example of a patient condition that is especially suitable for electronic monitoring, consider the use of electronic patient monitors to help monitor the temperature of a patient at a particular part of his or her body. Obviously the patient's body temperature in general is almost always of interest in a medical setting. Additionally, though, it is well known that a point measurement of the patient's temperature can be used to indicate the presence or absence of the patient, the presence and extent of moisture, the potential for development of pressure ulcers, etc.

Although a patient's body temperature might be measured in many different ways, thermocouples are of particular interest for purposes of the instant invention. Thermocouples are widely used in science and industry for both temperature measurement and temperature control. Broadly speaking, the thermocouple effect is based on the observation that in certain circumstances a temperature differential can be converted directly into electrical energy, with the amount of electrical energy so generated providing an estimate of the temperature. Conventional thermocouples are often formed by joining together a pair of dissimilar metal wires, the metals having been chosen so that a voltage is observed depending on the size of the temperature difference between the joined and free ends of the pair. The observed voltage (which might be several μV per degree Celsius of observed temperature difference) then provides an estimate of the temperature differential along the length of the pair of wires according to standard equations well known to those of ordinary skill in the art.

Conversely, if a voltage is applied to a thermocouple a temperature differential is created between the junction and the free ends of the two elements that comprise the thermocouple, with the junction being either cooled or heated depending on the direction of the applied DC current. If a number of such thermocouples are interconnected, a heating and cooling module (e.g., a Peltier module) may be constructed according to methods well known in the art. Several thermocouples that have been interconnected in series are often also commonly referred to as a thermopile.

As useful and versatile as modern thermocouples might be, they suffer from certain disadvantages, among which are that they are generally not suitable for use on flexible/irregularly surfaces such as a bed or chair. Thermocouples are often made of thin wire pairs so that the device responds more quickly to temperature changes, but such a construction can make the thermocouple somewhat fragile. Of course, in patient monitoring situations, placement of hardware that is fragile, sharp, and/or hard in contact with a patient's body risks discomfort and/or injury. Finally, since in many medical environments the patient sensor must be changed frequently because of soiling, movement of a different patient into that bed, etc., the expense associated with solid metal thermocouples can make their use in disposable sensors impractical.

Heretofore, as is well known in the patient monitoring arts, there has been a need for an invention to address and solve the above-described problems. Accordingly, it should now be recognized, as was recognized by the present inventor, that there exists, and has existed for some time, a very real need for a thermocouple that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

In accordance with a preferred embodiment of the instant invention, a patient temperature monitor is provided that is in the form of a patient monitor that is used in combination with thermocouple that has been printed or otherwise placed on a flexible surface such as a mat. The thermocouple sensor, and method of manufacturing same, that is taught herein is designed to produce a sensor that is more comfortable for the patient, more reliable and that can be manufactured with less cost than has heretofore been possible.

According to a first preferred embodiment, there is provided herein a method and apparatus for determining when moisture is present in a patient's bed or chair based on measurements of temperatures at locations underneath and adjacent to the patient. More particularly, in a preferred arrangement an initial temperature distribution will be determined for the patient using a sensor that can detect a temperature at multiple points within the bed, chair, etc. In a preferred variation, the sensor will be continuously checked for temperature changes by an electronic patient monitor that has been programmed for that purpose. In some instances (e.g., when the patient changes position or leaves the bed) the temperature changes are innocuous and unrelated to enuresis. Thus, when a temperature change is detected the instant invention will determine whether the change is due to patient movement (e.g., changing position or leaving the bed/chair) or wetness and, if due to wetness, an appropriate alarm will be sounded.

According to an aspect of the instant invention, there is provided a thermocouple sensor for use in patient monitoring which is created by silkscreen printing two finely powdered metals (or other thermocouple-active materials) onto a non-conductive printable substrate such as polyester. That is, and according to a first preferred embodiment, metallic ink, that has been formed from a finely powdered metal such as iron that has been combined with a suitable binder, would first be silk screened onto a non-conductive surface. This will preferably be followed by silk-screening a second metallic ink, which might be some combination of nickel and copper together with a suitable binder, onto the same surface so as to intersect the region that has been imprinted using the first metal ink. Note that in some preferred embodiments, the thermocouple will be printed on two different surfaces that are brought into contact during assembly or subsequently during use. Then, by attaching electrical connectors to each element of this screened combination, it will be possible to monitor temperature changes by measuring the voltage generated by this printed combination.

According to another aspect of the instant invention, there is provided a method of manufacturing a thermocouple patient sensor which involves screening finely powdered metal inks onto a nonconductive (or semi-conductive) surface. According to a first aspect of this invention, two dissimilar metals will be obtained in powdered form. Such powdered metals will preferably then be separately combined with a binding agent to produce two different inks that have thermocouple properties.

As a preferred next step, one of the two metalized inks will be selected and silk screened (e.g., screen printed, etc.) onto the non-conductive surface (or surfaces) according to a predetermined pattern. Then, preferably in a second pass, the second of the two metalized inks will be added, thereby forming one or more thermocouples. Following this, at least one pair of electrical contacts will be added to enable the amount of voltage generated by the thermocouples to be measured and, hence, the temperature estimated according to methods well known to those of ordinary skill in the art.

After the thermocouple pattern has been printed, it is preferred that a second non-conductive layer which is commensurate in size with the first be bonded thereto (e.g., by heat sealing, adhesive, etc.), thereby rendering the sensor resistant (or, preferably, impervious) to fluids. In one preferred arrangement the outer members will be comprised of a material such as polyester, preferably separated by one or more layers of polyethylene, the resulting “sandwich” being readily adapted to be heat sealed. In another preferred arrangement, one of the metalized inks will be printed on each of the non-conductive layers, with the inks coming into contact either when the two layers are assembled/bonded together or afterward during use if the intent is that the sensor functions as both a thermocouple and as a patient presence/absence monitor.

In still another preferred embodiment, rather than using a second plastic surface to bond to the first, a nonconductive layer of ink will be printed on top of the existing thermocouple, thereby reducing the materials that would be required to manufacture the instant thermal sensor while still shielding the patient from contact with the electrically charged thermocouple elements. Additionally, such an arrangement would have less thermal mass and would respond more readily to even subtle temperature changes.

Additionally, it should be noted and remembered that although the instant thermocouple sensor will preferably be created by silk-screening, other printing technologies could also be used including, without limitation, ink jet, offset printing, or any other printing method that is suitable for use with an ink that contains a powdered metal therein.

Finally, those of ordinary skill in the art will recognize that although the ink that is used to create the inventive thermocouple has often been referred to herein as a “metallic” ink, in reality the materials that are used in the inks need not necessarily be comprised of a powdered metal. Instead, a variety of non-metallic substances such as carbon, germanium, selenium, silicon, etc., could certainly be powdered and used in some circumstances. In brief, any material (or combination of materials) with an appropriate Seebeck coefficient could conceivably be produced in powdered form and used as a component of the instant invention.

The foregoing has outlined in broad terms the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Further, the disclosure that follows is intended to be pertinent to all alternatives, modifications and equivalents as may be included within the spirit and scope of the invention as defined by the appended claims. Finally, it should be understood that the phraseology and terminology employed herein are for the purpose of description and should not be regarded as limiting, unless the specification specifically so limits the invention.

While the instant invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

### BRIEF DESCRIPTION OF THE DRAWINGS

Other objects and advantages of the invention will become apparent upon reading the following detailed description and upon reference to the drawings in which:

FIG. 1 illustrates a preferred thermocouple arrangement.

FIG. 2 contains a preferred cross sectional view of the point of intersection of the embodiment of FIG. 1.

FIG. 3 illustrates a preferred configuration of a Peltier module which is comprised of thermocouples constructed according to the instant invention.

FIG. 4 contains a preferred thermocouple arrangement for use as patient exit monitor.

FIG. 5 illustrates the embodiment of FIG. 3 which has been modified to allow for more efficient heat transfer.

FIG. 6 contains a top view of a preferred thermocouple array and electronic monitor for use therewith.

FIG. 7 contains an illustration of a cross sectional view of the embodiment of FIG. 6.

FIG. 8 illustrates another preferred embodiment wherein a single thermocouple manufactured according to the preferred method has multiple contact points.

FIG. 9 contains a preferred Peltier module configuration using materials deposited thereon by printing according to the methods taught herein.

FIG. 10 illustrates the embodiment of FIG. 9 prior to assembly.

FIG. 11 contains another preferred embodiment which can function both as a thermocouple circuit and as a presence/absence circuit.

FIG. 12 illustrates the embodiment of FIG. 12 before and during compression by the weight of a patient.

FIG. 13 illustrates another preferred thermocouple arrangement wherein the thermocouple will only be activated when a patient is present.

FIGS. 14A and B illustrate the general environment of one aspect of the instant invention.

FIG. 15 contains a schematic illustration of a typical patient thermal distribution in a dry and a wet state.

FIG. 16 illustrates another possible thermal distribution.

FIG. 17 contains a schematic illustration of a preferred operating logic suitable for use with an electronic monitor tasked with monitoring the thermal sensor of the instant invention.

### DETAILED DESCRIPTION OF THE INVENTION

### General Environment of the Invention

Turning first to FIGS. 14A and 14B wherein the general environment of one specific embodiment of the instant invention is illustrated, in a typical arrangement a thermal patient sensor 1100 is placed on a hospital bed where it will lie beneath a portion of the reclining patient's body, usually the buttocks and/or shoulders. Generally speaking, the mat 1100/electronic monitor 1410 combination works as follows. When a patient is placed atop the mat 1100, the patient's presence is detected (e.g., by an increase in the temperature of the sensor). The patient's presence is sensed by the associated electronic patient monitor 1410 and, depending on its design, this may signal the monitor 1410 to begin monitoring the patient via the sensing mat 1100. Additionally, in some embodiments, the monitoring phase is initiated manually by the caregiver using a switch on the exterior of the monitor 1410 that has been provided for that purpose.

After the monitoring function is engaged, the monitor will typically establish a baseline measurement against which to judge future changes in patient's condition. For example, if the sensor is a thermal sensor, an initial temperature (or initial temperature distribution) will be obtained. The sensor 1100 is then monitored for changes in the initial condition. When such a change is sensed, the patient monitor 1410, which conventionally contains a microprocessor and associated software therein, then signals the caregiver per its pre-programmed instructions. In some cases, the signal will amount to an audible alarm or siren that is emitted from the unit 1410. In other cases, an electronic signal could also be sent to a remote nurses/caregivers station wirelessly or via electronic communications line 1420. In still another preferred arrangement, the patient monitor 1410 will sound an audio alarm locally and simultaneously send the alarm signal to the nurse's station. Note that additional electronic connections not pictured in this figure might include a monitor power cord to provide a source of AC power although, as generally pictured in this figure, the monitor 1410 can certainly be configured to be either battery (to include capacitive storage) or AC powered, although a battery or other mobile power source is generally preferred in the case of a monitor that is attached to a wheelchair.

In another common arrangement, and as is illustrated in FIG. 14B, a chair sensor 1450 might be placed in the seat of a wheel chair or the like for purposes of monitoring a patient seated therein. As has been described previously, a typical configuration utilizes a sensor 1450 which is connected to electronic chair monitor 1440 that is attached to the chair 1430. Because it is anticipated that the patient so monitored might want to be at least somewhat mobile, the monitor 1440 will usually be battery powered and will often signal its alarm via an integral speaker (or, e.g., via a wireless link), rather than via a hardwired nurse-call interface.

Broadly speaking, the electronic patient monitors that are referred to herein work by first sensing an initial status of a patient, and then generating a signal when that status changes (e.g., the patient changes position from laying or sitting to standing, the sensor changes from dry to wet, etc.).

General information relating to mat sensors and electronic monitors for use in patient monitoring may be found in U.S. Pat. Nos. 4,179,692, 4,295,133, 4,700,180, 5,600,108, 5,633,627, 5,640,145, 5,654,694, and 6,111,509 (which concerns electronic monitors generally), and 7,079,036 (which concerns using pulse width modulation to control an alarm volume). Additional information may be found in U.S. Pat. Nos. 4,484,043, 4,565,910, 5,554,835, 5,623,760, 6,417,777, 7,078,676 (sensor patents), U.S. Pat. No. 7,030,764 pertaining to monitor and method for reducing the risk of decubitus ulcers, and U.S. Pat. No. 6,065,727 (holsters for electronic monitors), the disclosures of all of which patents are all incorporated herein by reference. Further, U.S. Pat. No. 6,307,476 (discussing a sensing device which contains a validation circuit incorporated therein), and U.S. Pat. Nos. 6,544,200 (for automatically configured electronic monitor alarm parameters), 6,696,653 and 6,858,811 (for a binary switch and a method of its manufacture), 6,864,795 (for a lighted splash guard), 7,079,036 (for alarm volume control using pulse width modulation) and 6,897,781 (for an electronic patient monitor and white noise source for soothing a patient to sleep after they have turned) are similarly incorporated herein by reference.

### Preferred Embodiments

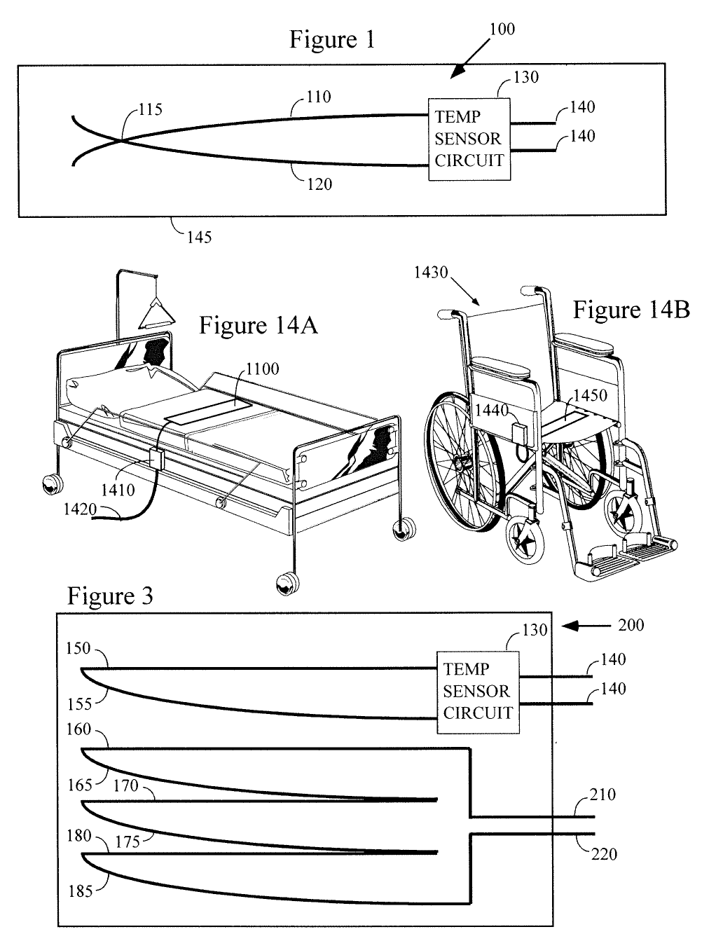

Turning to FIG. 1 wherein is illustrated a first preferred embodiment, there is provided a system for monitoring a patient's thermal state which uses a thermocouple sensor that was manufactured using silk screening or a similar printing process.

According to a first preferred embodiment and as is generally indicated in FIG. 1, a thermocouple sensor 100 will preferably be silk screened or otherwise printed onto a nonconductive surface 145 using inks that have been specially prepared for that purpose. In more particular, and as is described more fully hereinafter, at least two different inks will be used to form the thermocouple 100, each ink containing a substantial amount of a different powdered metal therein. The different inks will be used to print a pattern on the nonconductive surface that operates as a thermocouple, i.e., the two conductive arms 110 and 120 preferably intersect at a single point 115 as indicated. Thus, a temperature differential between the intersection point 115 and the reference junction (e.g., the temperature sensor interface circuit 130) will produce a voltage in the circuit 100, the magnitude of which is related to the temperature difference between the reference junction and the point of intersection 115. Of course, in the alternative, and as is discussed more fully below, if a current is applied to arms 110 and 120 that will result in a heating or cooling at the intersection point 115 depending on the polarity of the current.

In one preferred arrangement, the surface 145 on which the thermocouple 100 is printed will be comprised of one or more plastic-like materials such as polyester. Polyester, and especially polyester in sheet or film form, is preferred in applications wherein the temperatures that are to be measured are relatively low (e.g., from about 80 to 120 degrees Fahrenheit). This material is relatively inexpensive, flexible, and resistant to moisture which are properties that are especially desired in fields such as patient monitoring. That being said, those of ordinary skill in the art will recognize that in some instances it might be advantageous to utilize a printable medium that has some limited amount of conductivity (e.g., a semi-conductive material). Thus, although the preferred embodiment utilizes a medium that is nonconductive it should be noted and remembered that other possibilities are certainly possible and have been contemplated by the inventors.

According to a first preferred embodiment, and as is generally set out in FIG. 1, there is provided a thermocouple 100 that has been imprinted on one or more non-conductive surfaces 145. In one preferred embodiment, a first thermocouple arm 110 will be printed with ink that contains powdered metal therein. For example, the metal might be copper, cadmium, aluminum, platinum, rhodium, nickel-chromium, nickel-aluminum, lead, silver, gold, etc. and also combinations or alloys of the same. Those of ordinary skill in the art will recognize that many different metals might be employed, but certain metals are preferred for their predictable output voltages when used as a component of a thermocouple.

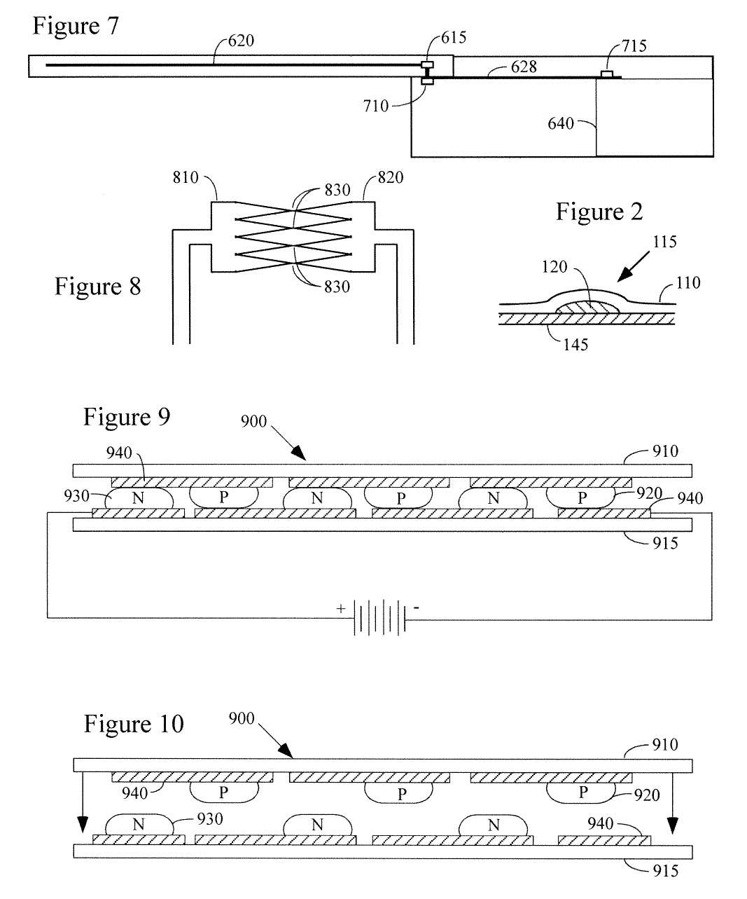

The second thermocouple arm 120 will then be printed (either on the same or on the opposite non-conductive substrate) so as to intersect arm 115 the first thermocouple element 110, and, further, will contain powdered metal ink of a sort that is calculated to create a thermocouple effect when joined where it intersects 115 with the first arm 110. As is best illustrated in the cross sectional view of the intersection point of the two arms (FIG. 2), it is preferred that the first aim 110 be in direct contact with the second aim 120 by, for example, printing it directly atop the other element. In some preferred embodiments, a nonconductive ink (paint, etc.) will be used to overprint the thermocouple arms 110 and 120, thereby sealing them against contact with the patient, fluids, etc.

Preferably, the thermocouple pair 110/120 will then be placed in electrical communication with a temperature sensor interface circuit 130, which is designed to measure the voltage generated by the thermocouple and correct that voltage by an amount that is related to the temperature at the sensor 130 which preferably is the reference junction for the thermocouple circuit 100. Those of ordinary skill in the art will recognize that many circuits of the same general sort as temperature circuit 130 are readily available and would be suitable for use with the instant invention.

Turning next to another preferred embodiment and as is generally indicated in FIG. 3, there is provided a thermocouple substantially as described previously, but wherein multiple thermocouples are arranged to form a module for heating and/or cooling (e.g., a Peltier module) and wherein multiple thermocouples are printed onto a non-conductive surface by silk screening or similar printing means. As has been described previously, it is preferred that each of the thermocouples in module 200 be placed on a non-conductive surface such as polyester or other plastic. Additionally, and as has been discussed previously, each of the arms of the thermocouple pairs is made of an ink containing a different powdered metal than that of the aim that intersects it. For example, arms 150 and 155 contain different powdered metals, arms 160 and 165 are printed with different powdered metals, etc. Although this type of module might be implemented in many different ways, it is preferred that one of the thermocouple pairs (e.g., thermocouple 150/155) be used as a temperature sensor so that the temperature of the module 200 may be determined for control purposes via electrical contacts 140, which explains the inclusion of temperature sensor interface circuit 130. It should be clear to those of ordinary skill in the art that the utilization of such a temperature sensor circuit 130 is not required and, as such, is only a preferred aspect of this particular embodiment.

Additionally, it should be clear by reference to FIG. 3 that in the preferred arrangement electrical contacts 210/220 will be used to deliver an electrical current to the thermocouple pairs 160-185, for purposes of heating or cooling depending on the polarity of the charge applied thereto.

FIG. 5 illustrates another preferred variant of the invention of FIG. 3. In the embodiment of FIG. 5, heat conductors 590 have been added at the point of intersection between the two dissimilar metallic inks. This enhancement would assist in the collection and distribution of heat, depending on whether the module 500 was used as a heating or cooling unit. In one preferred embodiment, the heat conductors 590 will be copper (or other heat conducting) disks that are placed into thermal communication with the intersection point of the thermocouple and preferably will be separated electrically from the junction by the application of a nonconductor to the underside of the collector 590 or atop the intersection.

FIG. 8 illustrates still another preferred embodiment, wherein a thermocouple has been created with a plurality of intersection points 830 that are configured in parallel, so that if one of these points 830 were to fail for some reason and result in a loss in electrical conductivity across that one point, the others would continue to operate. As is generally indicated in that figure, two dissimilar metal inks are used to print the arms 810 and 820 of the instant thermocouple. In this configuration, if one of the intersection points 830 between the two dissimilar metals becomes broken, the remaining points 830 will still function normally. Note that this figures illustrates one clear advantage of the instant invention, i.e., it allows uniquely shaped and configured thermocouples to be formed that could not be easily or economically formed using methods available in the prior art. Any shape that can be printed—whether functional or decorative—could potentially be used in forming a thermocouple according to the methods taught herein.

Finally, it should be clear to those of ordinary skill in the art that thermocouples formed according to the instant invention are suitable for any use in any application that a conventional thermocouple would be used, except that the instant invention will likely not be suitable for use at the highest temperatures. However, for applications wherein the expected temperatures may be found in a relatively modest temperature range (e.g., temperatures that are suitable for use with human subjects, say, within ±75° F. of room temperature), the instant invention would be ideal.

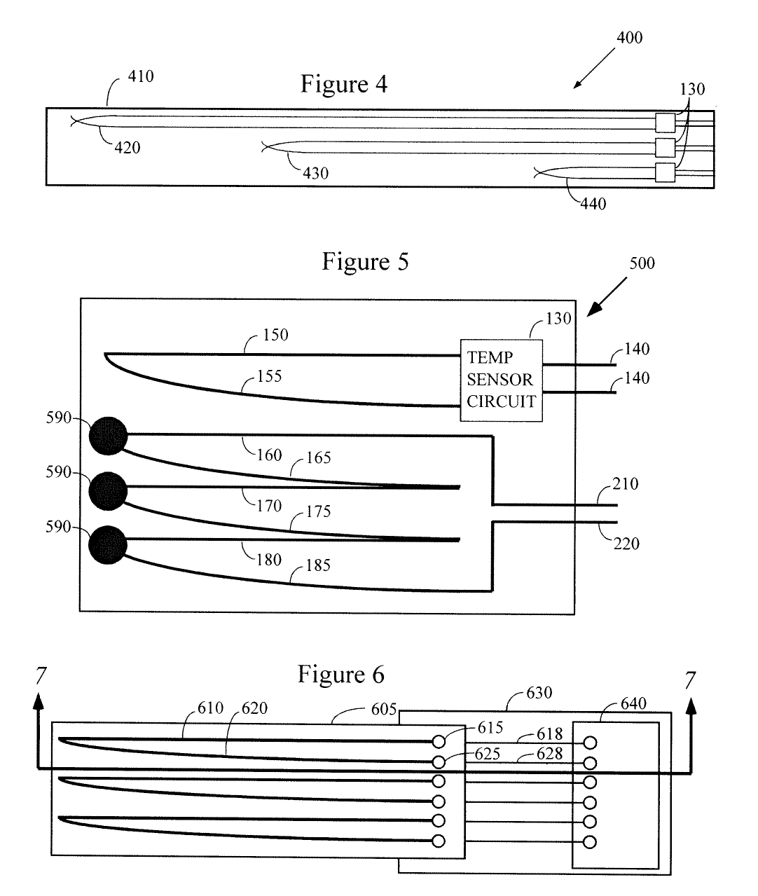

As an example of one application that would be well suited for use with a thermocouple of the sort taught herein, one or more of the embodiments 100 of FIG. 1 could readily be made into a sensor 400 (FIG. 4) for determining the presence or absence of a patient within a bed or chair. In one preferred arrangement, a plurality of thermocouples 420, 430, and 440 that have been formed according to the instant invention will be imprinted on a surface 410 that is made of a flexible, waterproof, and nonconductive material such as polyester (or, for example, layers of polyester). Preferably, the surface 410 upon which the thermocouples are printed will be sealed to another comparably sized surface of the same material, thereby enclosing the thermocouples 420-440 therein and protecting them from exposure to moisture, dust, and other contaminants. Then, when the instant sensor 400 is placed underneath a seated or lying patient, the thermocouples 420-440 will respond to the patient's body heat and a microprocessor or other signal conditioning device that is placed into electrical communication with temperature sensor circuits 140 will be able to determine a temperature from the thermocouple and, by virtue of that measurement, obtain an indication as to whether or not the patient is still present. In a preferred embodiment, the intersection points of the thermocouple elements 420, 430, and 440 will be arrayed in a linear (as is indicated in FIG. 4) and/or in a spatially distributed (i.e., in a linear or two dimensional) pattern that will allow an attached patient monitor to determine, not just the patient's body temperature at a point, but instead a temperature distribution of the patient's body at various points on the sensor.

As still another example of an application that could benefit from the user of the instant thermocouple 100, those of ordinary skill in the art will recognize that the instant invention would be especially suitable for use in detecting the early stages of pressure ulcer formation in an immobile patient. As is well known in the medial arts, pressure ulcers typically form at pressure points where the patient's body weight rests on bony prominences. People who are bedfast or long-term residents therein tend to develop pressure ulcers over the hip, spine, lower back, shoulder blades, elbows, and heels. Similarly, people who are confined to a wheelchair tend to develop pressure ulcers on the lower back, buttocks and legs. In either case, the pressure of the patient's weight temporarily cuts off the skin's blood supply to a portion of the weight bearing soft tissue. This injures the patient's skin cells and can cause those cells to die in a fairly short period of time unless the pressure is relieved and blood is allowed to flow to the ischemic tissue again. A generally recognized precursor to pressure ulcer formation is that the affected region of the soft tissue can change in temperature as compared with the rest of the patient's body. Thus, it may be possible to recognize and avert ulcer formation by continuously monitoring the patient's body temperature in regions of the body that could be subject to the development of pressure ulcers. The embodiment of FIG. 4 would be useful for this application.

FIGS. 6 and 7 illustrate how an electronic patient monitor 630 might be used to form a personal environmental control apparatus that utilizes a preferred embodiment of the instant invention. Not shown in FIGS. 6 and 7 are a power supply, a microprocessor or similar signal conditioning device, and (optionally) at least one temperature sensor. As is best seen in FIG. 6, the thermocouples of FIG. 5 would preferably be incorporated into a mat 605 or similar thin, planar, waterproof, flexible assembly that can be placed beneath a patient. Preferably there will be a plurality of thermocouple pairs 610/620, each of which is comprised of dissimilar metal inks as has been discussed previously. In the preferred arrangement the thermocouple pairs 610/620 will terminate within the mat 605 in connectors 615 and 625, each of which will preferably be of the same type of metal as that which is included in the metallic ink that was used to print the thermocouples. Each of the connectors 625/615 will preferably engage connectors within the monitor 630 of the same metal type. Finally, and as is illustrated most clearly in FIG. 7, the internal connector 710 will be preferably interconnected via a same-metal metallic wire 628/618 to a heat sink 725. The connector 715 could either be of the same or a different metal than the wire 628.

One purpose of this arrangement is to move the reference junction for temperature measurement inside of the monitor 630 and into contact with a heat sink 640, which might utilize fins, fans, etc., to dissipate (output) thermal energy that is provided thereto by the thermocouples. Of course, in the event that the thermocouples are cooling the heat sink 640 (e.g., if the goal is to apply heat to the patient via the thermocouples) the same fins, fans, etc., will serve to input thermal energy (i.e., to warm it). Those of ordinary skill in the art will recognize that this arrangement will make it possible to apply spot heating and cooling to a patient.

In one preferred arrangement, a temperature differential of about 5° F. might be generated between the reference temperature and the intersection point of the thermocouple by application of for example, about 300 milliamps of drive current. Those of ordinary skill in the art will recognize that there are many variations of the previous embodiment that could be constructed so as to yield alternative temperature differentials and/or require different amounts of drive current. Obviously, such properties are related to a choice of a particular set or combination of materials in the thermocouple ink, the selection of such being a design choice that is well within the capability of one of ordinary skill in the art.

According to another preferred embodiment and as is generally indicated in FIG. 9, there is provided a thermocouple 900 arrangement configured in the form of a Peltier module. As is indicated in this figure (which is a cross sectional view of the instant device), the “P” type 920 (i.e., “positive”) and “N” type 930 (i.e., “negative”) thermocouple elements are preferably printed in alternating parallel rows of pads atop discontinuous conductive elements 940 which are designed to form a conductive bridge between adjacent thermocouple elements 920 and 930. Substrates 910 and 915 are preferably non-conductive as has been discussed previously. In operation, after the power source has been activated it delivers a predetermined current to the conductive elements 940 which interconnect the “P” 920 and “N” 930 thermocouple elements, thereby either heating or cooling the module 900 depending on the direction of the current flow.

FIG. 10 illustrates more clearly how the embodiment of FIG. 9 might appear prior to assembly, i.e., after preparing upper and lower substrates 910 and 915 and bringing them into alignment. The “N” type 930 and “P” type 920 thermocouple elements will preferably have been previously printed into separate substrate members 910 and 915 before the two substrates 910 and 915 are brought together for purposes of joining them together and sealing them at least around their peripheries. As is well known to those of ordinary skill in the art, the two members 910/915 could be joined together in many ways including heat sealing, adhesives, etc.

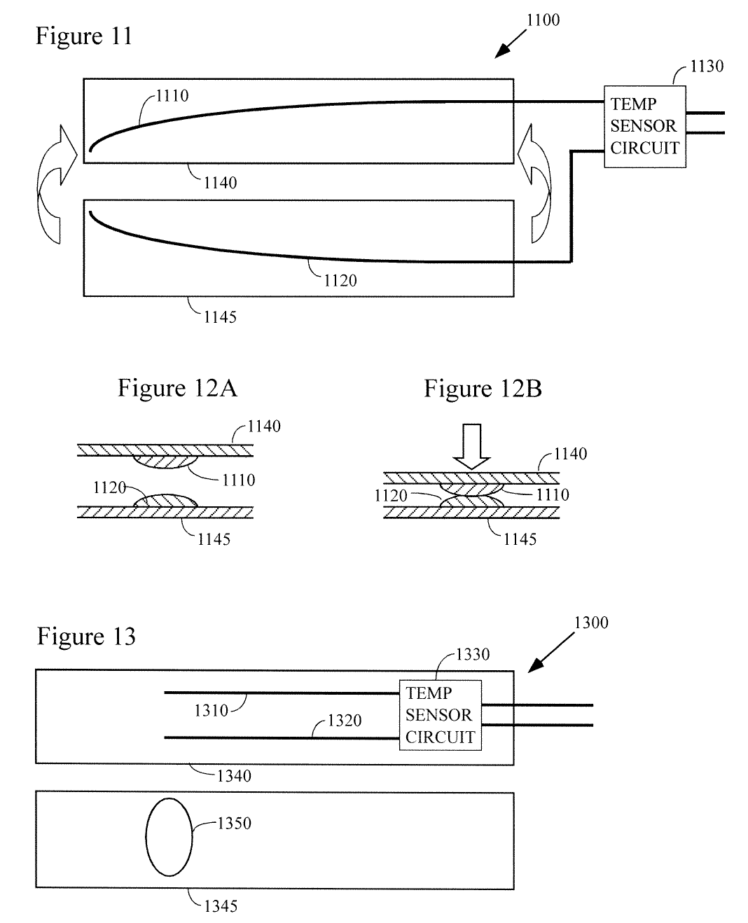

In still another preferred embodiment, that the instant inventors have devised a thermocouple substantially similar to that discussed previously, but which also functions as a sensor for monitoring, for example, the presence or absence of a patient in a bed. As is generally indicated in FIG. 11, in this preferred variation the sensor 1100 will preferably be formed using two separate members 1140 and 1145, with one arm 1110/1120 of the thermocouple printed on each. Assembly of the sensor 1100 will preferably include insertion of a resilient/elastic spacing member between the two members 1140 and 1145. As is conventionally done, the spacing member will have one or more apertures therethrough to allow the thermocouple arms 1110/1120 to remain separated so long as the sensor 1100 is not under compression but be forced into contact through such aperture(s) when compression is applied. Although the spacer is not pictured in FIG. 11, the use of this sort of element is well known to those of ordinary skill in the pressure sensitive switch arts as is illustrated, for example, in U.S. Pat. No. 6,417,777, the disclosure of which is incorporated herein by reference. After the sensor 1100 is assembled (e.g., by flipping the substrate 1145, placing it atop substrate 1140, inserting the spacer, and sealing the edges according to methods well known to those of ordinary skill in the pressure sensitive switch arts) it will preferably be placed underneath a patient. In the preferred arrangement the two arms 1110/1120 will not be in electrical contact until after pressure (e.g., a patient's weight) is placed on the sensor (e.g., FIG. 12A). However, if weight is applied (FIG. 12B), the sensor 1100 will collapse, causing the thermocouple arms 1110/11120 to come into contact and thereby completing the thermocouple circuit so that an attached signal processing device can read and interpret signals from the temperature sensor circuit 1130.

In operation and as is generally indicated in FIG. 14, the sensor 1100 (which would conventionally take the form of a mat) will be placed in a bed or chair. A separate electronic patient monitor 1410 will monitor the status of the sensor 1100 and, in one preferred arrangement, communicate that status to a remote caregiver via, for example, a connection 1420 to a nurse call, an audio alarm, or similar means. Wireless connectivity to a remote caregiver is, of course, a well-known alternative to the wired connection 1420 that is illustrated in FIG. 14. Preferably the monitor 1410 will include a microprocessor or similar programmable circuitry (e.g., a gate array, PLD, etc.) to allow it to process and respond to signals from the sensor 1100. When a patient is present on the sensor 1100, the patient's weight will compress it and complete the thermocouple circuit. The attached monitor 1410 will then receive temperature data from the sensor 1100 and/or be able to initiate heating/cooling of the patient via one or more thermocouple elements within the sensor 1100 as has been discussed previously. However, if the patient should leave the bed, the thermocouple circuit will be broken and the monitor 1410 will not be able to detect temperature readings. In such an instance, depending on the programming of the monitor, a caregiver might be notified of that fact via an audio alarm built into the monitor 1410 and/or a signal might be sent to a remote caregiver.

As still another preferred variation of the previous pressure activated thermocouple, there is provided the arrangement of FIG. 13 wherein both thermocouple arms 1310/1320 are printed on the same printable medium 1340. In this embodiment, a conductive pad 1350 will preferably be placed opposite the thermocouple arms 1310/1320 and brings the two into electrical contact when pressure is applied to the sensor 1300. As before, the pad 1350 will preferably be kept away from the thermocouple arms 1310/1320 by a resilient central spacer (not shown), the stiffness of the substrate material(s) 1340/1345, or some similar mechanism. As before, when pressure is brought to bear on the sensor 1300 an attached monitoring device will be able to read the temperature sensor circuit 1330 and interpret the signals (or lack of same) obtained therefrom.

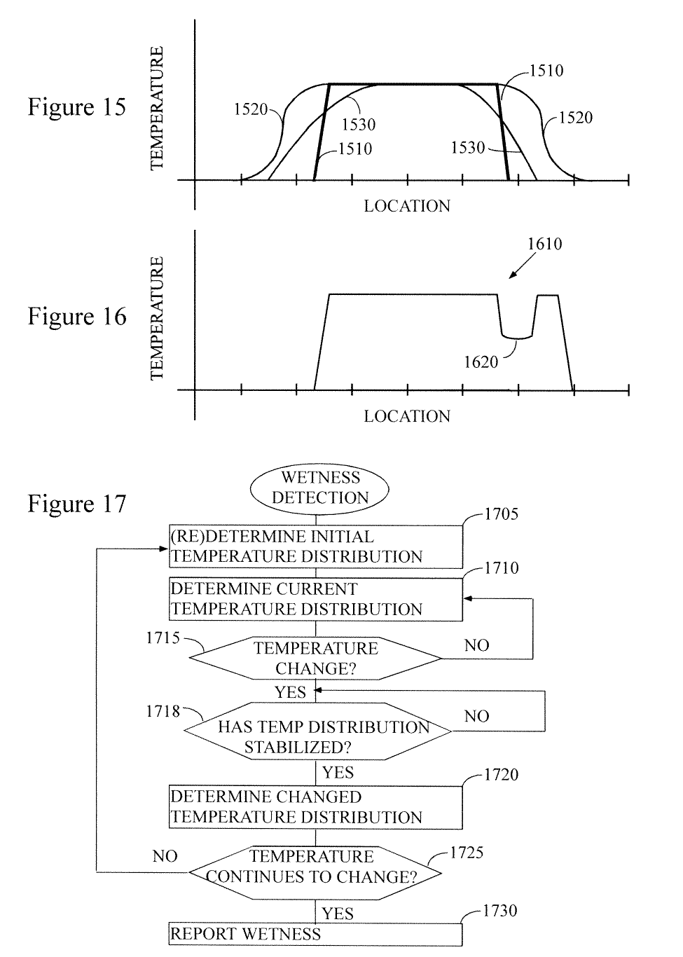

According to still another preferred embodiment there is provided a patient thermal sensor for use in a medical environment, wherein the thermal sensor is used to detect the presence or absence of moisture in a bed. In a preferred embodiment, a sensor that is similar in concept to that illustrated in FIG. 4 will be utilized. That is, in the preferred arrangement a plurality of thermocouple sensors will be printed across the length of a mat, the advantage of such an arrangement being that it will be possible to obtain temperature readings as a function of offset along the length of the mat 400. Preferably the thermocouples will be spaced densely enough to allow a temperature profile of the sort illustrated in FIG. 15 to be assembled.

Turning next to FIG. 15, this illustrates how a patient's temperature profile might change depending on whether or not moisture (e.g., enuresis) is present in the bed with the patient. As is illustrated in this figure, curve 1510 is a schematic representation of the temperature profile of the sort that might be obtained from a sensor 400 that is situated transversely to the patient across the width of the bed (e.g., FIG. 14) when the patient is dry. As might be expected, the temperature readings would be expected to be at or near maximum (i.e., about 98.6° F. in a patient who is not running a fever) directly underneath a stationary patient and then, as measurements are taken adjacent to the patient, decrease relatively quickly to a temperature that is approximately equal to the ambient temperature of the room (curve 1510). Additionally, if the patient were to exit the bed or chair, the temperature recorded by the sensors would quickly decrease to near the ambient temperature, thereby providing an indication that the patient was no long present and that an alarm should be sounded if the electronic monitor is so programmed.

On the other hand, when moisture from a patient (or other source) is introduced (e.g., curve 1520) generally speaking the patient's temperature distribution will initially tend to be much broader, thereby reflecting the fact that, at least in the case of urine, the liquid will be warmer than the ambient temperature. Then, as the moisture beings to evaporate, the temperatures that are measured away from the body (but within the wet region) will tend to cool rapidly and could, temporarily, even become cooler than the ambient temperature.

In some cases, if the temperature in the bed or chair is repeatedly measured over some period of time, eventually the temperature distribution will likely change to resemble curve 1530. As is generally suggested by this figure, when a patient's bedding is wet it will tend to conduct heat away from the patient and measurements taken in the proximity of the patient will be elevated relative to the ambient temperature but cooler than the patient's body temperature because of evaporation, etc.

The curves of FIG. 15 suggest a general approach to identifying when a patient has wet the bed. In more particular and as is illustrated in FIG. 17, in a preferred arrangement an initial temperature distribution will be determined (step 1705). Normally the temperature distribution would be expected to take a that shape similar to that which was discussed in connection with FIG. 15 (curve 1510), but obviously other curve shapes would certainly be possible.

Next, and preferably, the monitor will enter a loop (steps 1710 and 1715) that watches the entire patient temperature profile for changes. It should be clear that as long as the patient remains essentially motionless, his or her thermal profile (e.g., curve 1510) is unlikely to change significantly after it has settled down to a steady state temperature distribution. Note that, for purposes of the instant disclosure, “steady state” does not necessarily indicate any particular period of time. More particularly, it should not be interpreted as requiring tens of minutes or hours. Instead, it should be understood that this term is merely used to indicate a situation where the temperature (or temperature distribution) is relatively stable which might be the case only a few seconds after the patient has returned to the bed, moved to a new location, etc.

After a change (preferably a significant change) in the temperature distribution is detected (the “YES” branch of decision item 1715), the instant invention will preferably continue to monitor the patient's temperature distribution at least until it stabilizes, if only momentarily. Note that a different temperature distribution response will tend to be observed depending on whether the change is associated with a relocation event or urination In some preferred embodiments, if the changed temperature distribution is associated with a patient relocation in the bed or chair, the newly-warmed sensors will increase from room temperature to body-temperature maximum and remain at that temperature. The recently vacated sensors will then begin to cool toward room temperature. On the other hand, if the changed temperature distribution is associated with enuresis, one or more of the unoccupied temperature sensors adjacent to the patient's body will show a rapid increase to near body temperature followed by a relatively rapid fall off back toward room temperature. Additionally, in the case of enuresis, the apparent “width” of the patient (as measured by the temperature footprint) will tend to temporarily increase, another indication that the bed is wet.

In terms of determining when the new temperature distribution has stabilized, those of ordinary skill in the art will readily be able to devise alternatives, but one preferred measure of stability would be to note when the temperature at each point away from the likely location of the patient's body has reached a maximum temperature and has just begun to decrease (step 1718). Thus, for purposes of the instant disclosure, a “stabilized” temperature distribution should be understood to be even a temporary condition where multiple sensors are at or near new maximum values.

After the temperature distribution has stabilized, the instant invention will preferably save it for comparison against future temperature changes (step 1725). As is indicated in FIG. 17, if the stabilized temperature is maintained for some predetermined period of time (e.g., 60 seconds or so) the temperature change will preferably be associated with a patient move to a new location within the bed or chair (the “NO” branch of decision item 1725).

On the other hand, if the temperature distribution as measured by several different (preferably adjacent) sensors begins to decrease from a recent maximum (the “YES” branch of step 1725) or if the slope of the curve 1520 begins to change as measured by sensors proximate to the edge of the patient's body, etc., the instant invention will preferably report a wetness condition to the caregiver (e.g., by an audible alarm at the patient's bedside, transmission of an alarm via the nurse system, etc.).

Those of ordinary skill in the art will recognize that the examples given in FIG. 15 are only designed to illustrate the general nature of the sorts of measurements that might be taken and the uses to which those measurements might be applied. Of course, the observed heat distribution patterns will likely be more complicated than the one illustrated in this figure. For example, FIG. 16 illustrates the sort of heat distribution pattern 1610 that might be observed in a reclining patient where one limb is held slightly away from the body in the bed, where the valley 1620 indicates a cooler area that is not directly beneath some portion of the patient's body. Obviously, depending on the location of the sensor array (e.g., under the shoulders, under the mid back, under the hips, etc.) different thermal patterns might be observed. However, those of ordinary skill in the art will be readily able to recognize such patterns and understand how the foregoing approach might be modified in the presence of wetness in the bed or chair.

Turning next to a preferred method of manufacturing the instant invention, there is provided a method for printing thermocouple elements on one or more nonconductive surfaces that utilize silk screening or a similar printing mechanism. In the preferred embodiment and as a first step, powdered metal of two different kinds will be obtained. These products are readily available commercially and can be ordered in particle sizes from very fine to coarse (e.g., from about 0.1 to 1000 microns) for a variety of different metals. The choice of a particle size will be dependent to some extent on the particular application and the methodology by which particles are applied to the insulating substrate. Those of ordinary skill in the art will recognize that a certain amount of experimentation may be necessary in order to find a best particle size for a particular application.

As a next preferred step, each of the powdered conductive materials (i.e., powdered metals in this embodiment) will be combined with at least one binding agent and, additionally if needed, one or more solvents or other carriers to form a thermocouple ink. The choice of a binder will depend at least on part on the nature of the surface upon which the ink is to be deposited and the application method used; and should be chosen so that the powdered conductive material will remain firmly affixed to the selected surface and in electrical communication with the other ink. Additionally, it would be advantageous if the binder were at least somewhat electrically conductive.

The function of the solvent, if it is used, is to increase the liquidity and mobility (e.g., decrease the surface tension, increase the wettability, etc.) of the resulting ink (i.e., decrease its viscosity) so that it can be applied easily. Volatile and/or nonvolatile solvents might be used depending on the particular application. Note that the composition of this component might need to be varied depending on the type of metal powder, the binder, and even the temperature and humidity at the time the thermocouples are to be printed, as is well known to those of ordinary skill in the printing arts.

The mixture of metal particles, binder, and solvents will then next be loaded into the printing device. As will be discussed at greater length below, preferably this will be a silk-screen printing apparatus. However, those of ordinary skill in the art will recognize that an ink jet printer, a color laser printer, offset printing, web-type printing, intaglio printing, screened/masked printing, vacuum deposition, and many other printing technologies could be used to print the thermocouple pattern. All that is required is that the ink dispensing mechanism be capable of printing multiple ink types (to include printing a single type of ink in two different passes) onto one or more selected surfaces.

However, in the instance that silk screen printing is employed, it is preferred that the screen be made of silk, stainless steel wire mesh cloth, monofilament mesh or a similar material. Clearly, the size of the mesh openings will be chosen, at least in part, as a function of the particle size in the ink. The pattern of the thermocouple(s) will be imprinted on this surface according to methods well known to those of ordinary skill in the art, e.g. by coating the screen with a photoactive emulsion, placing a “positive” of the thermocouple pattern in close proximity to the screen, and then exposing the combination to light, thereby creating a template through which the ink may be applied to the substrate. Preferably at least two indexed screens will be utilized, one for each type of metallic ink.

As a next preferred step, the substrate material(s) upon which the thermocouples are to be printed is placed in position for printing. As has been described previously, almost any nonconductive surface might be adapted for use as a substrate with the instant invention including, without limitation, plastics, rubber, cloth, ceramics, glass, etc. That being said, the instant invention will likely work best when placed on relatively inelastic materials.

Preferably, and as a next step, a first of the two screens will be selected and one of the metallic inks applied thereto according to methods well known to those of ordinary skill in the art. This will then preferably be followed by the application of the second ink (on the same or opposite side) by using the second screen. It should be clear that by using silkscreen methods, it would be straightforward to create the sort of material overlap as is illustrated in FIG. 2.

In one preferred embodiment the thermocouple legs will have a printed width of about 0.1 inches although it should be clear that many other widths could be appropriate depending on the particular application. It is expected that some degree of experimentation might be necessary in order to choose an appropriate width, since the width will likely vary depending, at least, on the thermocouple material in the ink, the binder or solvent, particle size, the substrate, etc.

In another preferred embodiment, both thermocouple arms will be printed on the same substrate member and then the thermocouple will be sealed from contact with fluids by printing or otherwise applying a coat of a nonconducting material such as polyester, polyethylene, etc., on top of the printed thermocouple and any other conductive material. In this arrangement, the coating will act analogously to a second substrate member.

### CONCLUSIONS

It should be noted that the various temperatures, materials, thicknesses, and other measurements associated with preferred embodiments disclosed herein are given for purposes of illustration only and should not construed to limit the practice of the subject matter claimed hereinafter. For example, although a polyester mat is a preferred substrate for the inventive thermocouples, that is only one of many thermally conductive materials that would be suitable for use with the instant invention. Of course, at minimum, the substrate must be electrically non-conductive. Additionally, it must be a surface that can accept a printed image. Beyond that, there are no specific material requirements and any number of non-conductive materials could be used (e.g., solid surfaces, cloth, rubber, polyester, plastics including polyethylene napthylate, polypropylenes, polycarbonates, high density polyethylene, polyurethane polystyrene, plastic impregnated textiles and webs, polyvinyl fluoride, plastic impregnated paper, ethyl-vinyl acetate, polyethylene, ethylene methyl acetate in mixture with ionomers, combinations of copolymers, ethylene acrylic acid, acetyl copolymers, laminates of any of the foregoing, etc.).

Additionally, it should be noted and remembered that although inks that are comprised of powdered metals are the preferred embodiment, there are other non-metallic substances that could be used instead. For example, non-metallic conductive substances such as carbon, germanium, selenium, silicon, etc., could certainly be powdered and incorporated into an ink according to the methods taught herein. In brief, any combination of materials that have appropriate Seebeck coefficients (i.e., one thermocouple ink being comprised of a material with a positive coefficient and the other with a negative one) and that can be obtained in powdered form could possibly be used to form a printed thermocouple according to the methods of the instant invention.

Further, although the instant thermocouple embodiments are primarily intended for heating and cooling, those of ordinary skill in the art will recognize that it is possible to use the instant invention to create, for example, a presence/absence detector that could be placed under a patient and that would make it possible for an attached electronic patient monitor to determine whether or not the patient is in contact with the detector (e.g., by monitoring for changes in temperature and/or continuity).

Additionally, those of ordinary skill in the art will recognize that a clear advantage of the instant method and apparatus is that it can create thermocouples on virtually any nonconductive substrate. Prior art methods that require sintering or melting are not suitable for use with substrates such as plastics that have relatively low melting points. Further, the instant method is suitable for use on flexible and porous materials such as fabric. Indeed, the instant inventors have determined that thermocouples that are printed on clothing could be used to heat or cool an individual, e.g., consider the case of a shirt that has a battery operated Peltier module imprinted thereon that could provide heating in the winter and cooling in the summer.

Those of ordinary skill in the art will recognize that there are many active devices that could serve for purposes of the instant invention as active portion of the patient monitor including, of course, a conventional microprocessor. More generally, the instant invention preferably includes an electronic monitor that utilizes some sort of active device, i.e., one that is programmable in some sense, is capable of recognizing signals from an attached patient sensing device, and is capable of initiating an alarm or generating an alarm sound in response to a patient condition, such alarm sound being transmitted to an internal, external, or remote speaker. Of course, these sorts of modest requirements may be satisfied by any number of programmable logic devices (“PLD”) including, without limitation, gate arrays, FPGA's (i.e., field programmable gate arrays), CPLD's (i.e., complex PLD's), EPLD's (i.e., erasable PLD's), SPLD's (i.e., simple PLD's), PAL's (programmable array logic), FPLA's (i.e., field programmable logic array), FPLS (i.e., fuse programmable logic sequencers), GAL (i.e., generic array logic), PLA (i.e., programmable logic array), FPAA (i.e., field programmable analog array), PsoC (i.e., programmable system-on-chip), SoC (i.e., system-on-chip), CsoC (i.e., configurable system-on-chip), ASIC (i.e., application specific integrated chip), etc., as those acronyms and their associated devices are known and used in the art. Further, those of ordinary skill in the art will recognize that many of these sorts of devices contain microprocessors integral thereto. Thus, for purposes of the instant disclosure the terms “processor,” “microprocessor” and “CPU” (i.e., central processing unit) should be interpreted to take the broadest possible meaning herein, and it should be noted that such meaning is intended to include any PLD or other programmable device of the general sort described above.

Note also that even though a microprocessor-based monitor is the preferred configuration, those of ordinary skill in the art will recognize that discrete components could also be used to duplicate the necessary functionality. Thus, for purposes of the instant invention an electronic patient monitor should be understood to include both microprocessor and non-microprocessor devices.

Thus, it is apparent that there has been provided, in accordance with the invention, a monitor and method of operation of the monitor that fully satisfies the objects, aims and advantages set forth above. While the invention has been described in conjunction with specific embodiments thereof, it is evident that many alternatives, modifications and variations will be apparent to those skilled in the art and in light of the foregoing description. Accordingly, it is intended to embrace all such alternatives, modifications and variations as fall within the spirit of the appended claims.

What is claimed is:

1. A system for monitoring a patient's condition, comprising:
(a) an electronic patient monitor, said electronic patient monitor having a CPU therein, said CPU being positionable to be in electronic communication with a patient sensor placed proximate to the patient, said CPU being at least programmed to monitor the patient's temperature using said patient sensor and initiating an alarm if the patient's temperature changes, wherein said patient sensor comprises:
(a1) a first flexible nonconductive substantially planar medium with an upper surface and a lower surface, at least said upper surface being suitable for printing thereon;
(a2) a first thermocouple element printed on said first medium upper surface, said first thermocouple element being comprised of a first powdered ink material;
(a3) a second thermocouple element printed on said upper surface, wherein at least a portion of said second thermocouple element is in electrical contact with said first thermocouple element, said second thermocouple element being comprised of a second powdered ink material different from said first powdered ink material, wherein said first and said second thermocouple elements taken together produce a thermocouple effect, said first thermocouple element and said second thermocouple element taken together comprising a thermocouple;
(a4) a first electrical connector in electrical communication with said first thermocouple element; and,
(a5) a second electrical connector in electrical communication with said second thermocouple element, said first and second electrical connectors being in electronic communication with said CPU.

2. The system for monitoring a patient's condition according to claim 1, further comprising:
(a6) a second flexible nonconductive substantially planar medium sized to be commensurate with said first medium, said first and second medium being sealed together along a common perimeter, said upper surface of said first medium facing said second medium, thereby sealing said thermocouple between said first medium and said second medium.

3. The system for monitoring a patient's condition according to claim 1, wherein CPU is programmed to perforin the steps of:
(1) using at least said first and second thermocouple elements to determine a steady state temperature of the patient,
(2) repeatedly using said first and second thermocouple elements to redetermine the temperature of the patient until a redetermined temperature of the patient is different from the steady state temperature, and,
(3) initiating an alarm if the redetermined temperature of the patient is different from the steady state temperature.

4. The system for monitoring a patient's condition of claim 1, wherein there are a plurality of thermocouples printed on said first medium in a spatially spaced apart relation.

5. The system for monitoring a patient's condition according to claim 4, wherein said electronic patient monitor contains a microprocessor, said microprocessor being programmed to perform the steps of:
(1) using said thermocouple to determine a steady state temperature distribution of the patient,
(2) repeatedly redetermining the temperature distribution of the patient until the redetermined temperature distribution of the patient is different from the steady state temperature, and,
(3) initiating an alarm if the redetermined temperature of the patient is different from the steady state temperature.

6. The system for monitoring a patient's condition according to claim 4, wherein said electronic patient monitor contains a microprocessor, said microprocessor being programmed to perform the steps of:
(1) using said thermocouple to determine a steady state temperature distribution of the patient,
(2) repeatedly redetermining the temperature distribution of the patient until the redetermined temperature distribution of the patient is different from the steady state temperature, and,
(3) if the redetermined temperature distribution of the patient is changed from the steady state temperature distribution and if the redetermined temperature distribution is broader than the steady state temperature distribution, determining that the patient is wet and initiating an alarm.

7. The system for monitoring a patient's condition according to claim 1, wherein said medium is comprised of a material selected from a group consisting of plastic, cloth, rubber, polyester polyethylene napthylate, polypropylene, polycarbonate, high density polyethylene, polyurethane polystyrene, plastic impregnated textile, plastic impregnated web, polyvinyl fluoride, plastic impregnated paper, ethyl-vinyl acetate, polyethylene, ethylene methyl acetate in mixture with ionomers, ethylene acrylic acid, and acetyl copolymers.

8. The system for monitoring a patient's condition according to claim 1, wherein said first and second thermocouple elements are printed on said substrate using silk-screen printing.

9. The system for monitoring a patient's condition according to claim 1, wherein said first and second powdered ink materials each contain at least one powdered metal selected from a group consisting of copper, cadmium, aluminum, platinum, rhodium, nickel-chromium, nickel-aluminum, iron, tungsten, lead, silver, and gold.

10. The system for monitoring a patient's condition according to claim 1, wherein
said first powdered ink material comprises a first powdered metal and a first binding agent, and,
said second powdered ink material comprises a second powdered metal different from said first powdered metal and a second binding agent.

11. The system for monitoring a patient's condition according to claim 10, wherein said first and second binding agents are a same binding agent.

12. A patient monitoring system, comprising:
(a) a first nonconductive substantially planar substrate with an upper surface and a lower surface, at least said upper surface being suitable for printing thereon;
(b) a thermocouple printed on said substrate upper surface, said thermocouple being comprised of
(b1) a first powdered ink thermocouple element printed on said substrate upper surface, and,
(b2) a second powdered ink thermocouple element printed on said substrate upper surface, wherein at least a portion of said second thermocouple element is in electrical contact with said first thermocouple element, said second thermocouple element being comprised of a second powdered ink material different from said first powdered ink material, wherein said first and said second thermocouple elements taken together produce a thermocouple effect;
(c) a first electrical connector in electrical communication with said first thermocouple element;
(d) a second electrical connector in electrical communication with said second thermocouple element; and,
(e) an electronic patient monitor in electronic communication with said first and second electrical connectors, said electronic patient monitor containing a microprocessor therein, said microprocessor being programmed to at least perform the steps of
(e1) using said first and second electrical connectors to determine a patient temperature,
(e2) continuing to determine the patient temperature using said first and second electrical connectors until the patient temperature changes, and,
(e3) after the patient temperature changes, activating an alarm.

13. The patient monitoring system of claim 12, wherein there are a plurality of thermocouples printed on said substrate in a spaced apart configuration.

14. The patient monitoring system according to claim 12, further comprising:
(f) a second nonconductive substantially planar substrate sized to be commensurate with said first substrate, said first and second substrate being sealed together along a common perimeter, said upper surface of said first substrate facing said second substrate, thereby sealing said thermocouple between said first medium and said second substrate.

15. A method of detecting wetness in a patient, wherein is provided a patient sensor having a plurality of spatially temperature sensors therein, comprising the steps of:
(a) using said plurality of spaced apart temperature sensors to determine a steady state temperature distribution of the patient;
(b) repeatedly redetermining the temperature distribution of the patient until the redetermined temperature distribution is different from the steady state temperature distribution;
(c) if the redetermined temperature distribution of the patient is different from the steady state temperature distribution and if the redetermined temperature distribution is broader than the steady state temperature distribution,
(c1) determining that the patient is wet, and
(c2) initiating an alarm.

16. The method according to claim 16, wherein step (c2) comprises the step of:
(i) initiating an audible alarm.

17. The method according to claim 16, wherein step (c2) comprises the step of:
(i) initiating an alarm through a nurse call system.

18. A system for monitoring a patient's condition, comprising:
(a) an electronic patient monitor, said electronic patient monitor having a CPU therein, said CPU being positionable to be in electronic communication with a patient thermal sensor placed proximate to the patient, said CPU being at least programmed to monitor the patient's temperature using said patient thermal sensor and initiating an alarm if the patient's temperature changes, wherein said thermal patient sensor comprises:
(a1) a first flexible nonconductive substantially planar medium with a first surface suitable for printing thereon;
(a2) a first thermocouple element printed on said first medium first surface, said first thermocouple element being comprised of a first powdered ink material;
(a3) a second flexible nonconductive substantially planar medium with a second surface suitable for printing thereon;
(a3) a second thermocouple element printed on said second surface, wherein said second thermocouple element is in electrical communication with said first thermocouple element, said second thermocouple element being comprised of a second powdered ink material different from said first powdered ink material, wherein said first and said second thermocouple elements taken together produce a thermocouple effect, said first thermocouple element and said second thermocouple element taken together comprising a thermocouple;
(a4) a first electrical connector in electrical communication with said first thermocouple element; and,
(a5) a second electrical connector in electrical communication with said second thermocouple element, said first and second electrical connectors being in electronic communication with said CPU.

19. The system for monitoring a patient's condition of claim 18, wherein said first medium and said second medium are a same medium, and wherein said first surface and said second surface are a same surface.
